(19) United States
(12) Patent Application Publication
(10) Pub. No.: US 2011/0051017 A1
(43) Pub. Date: Mar. 3, 2011

(54) METHOD FOR PROCESSING SIGNAL, TRANSMITTING APPARATUS, RECEIVING APPARATUS AND DISPLAY APPARATUS

(76) Inventors: Bong Kun KIM, Pyeongtaek-si (KR); Taek Soo Kim, Pyeongtaek-si (KR)

(21) Appl. No.: 12/796,570

(22) Filed: Jun. 8, 2010

(30) Foreign Application Priority Data
Sep. 1, 2009 (KR) 10-2009-0082198

(51) Int. Cl. H04N 5/44

(52) U.S. Cl. 348/734; 725/153; 348/E05.096

(57) ABSTRACT

A signal, a transmitting apparatus, a receiving apparatus, a display apparatus and a method for processing a signal in a receiving apparatus connected with a transmitting apparatus through a wireless network, the method including: receiving the signal; receiving a request for storing the received signal; and transmitting and storing the received signal to and in the transmitting apparatus.

### CROSS-REFERENCE TO RELATED APPLICATIONS

Pursuant to 35 U.S.C. §119(a), this application claims the benefit of earlier filing date and right of priority to Korean Application No. 10-2009-0082198, filed on Sep. 1, 2009, the contents of which are hereby incorporated by reference herein in their entirety.

### BACKGROUND OF THE INVENTION

1. Field of the Invention

The present invention relates to a method and an apparatus for receiving a signal and, more particularly, to a method and an apparatus for transmitting and receiving a media signal by using wireless communication.

2. Discussion of the Related Art

In general, a display apparatus includes a receiving unit that receives a media signal including video and audio from a broadcasting system, a cable system, and other external apparatuses (VCR, DVD, etc.) and processes and outputs the received media signal and a display unit that displays the processed video of the media signal on a screen.

Meanwhile, the receiving unit and the display unit may be individually separated from each other. In recent years, a wireless type display system has been provided, which transmits a media signal received by using an additional receiver to the display apparatus through wireless communication and displays the transmitted media signal on the display.

### SUMMARY OF THE INVENTION

An object of the present invention is to provide a method for processing a signal capable of efficiently managing signals transmitted and received by using a wireless network, a transmitting apparatus, a receiving apparatus and display apparatus thereof.

According to an embodiment of the present invention, there is a method for processing a signal in a receiving apparatus connected with a transmitting apparatus through a wireless network includes: receiving the signal; receiving a request for storing the received signal; and transmitting and storing the received signal to and in the transmitting apparatus.

A receiving apparatus according to the embodiment of the present invention may be implemented to perform the above-described signal processing method.

According to another embodiment of the present invention, there is a method for processing a signal in a transmitting apparatus connected with a receiving apparatus through a wireless network includes: receiving the signal; verifying whether or not an error occurs in the wireless network; storing the received signal when the error occurs in the wireless network; and transmitting the stored signal to the receiving apparatus after the error of the wireless network is restored.

A transmitting apparatus according to the embodiment of the present invention may be implemented to perform the above-described signal processing method.

Also disclosed is a method for controllably storing data in a remote storage device by a first device, the method including: wirelessly receiving the data by the first device and via a wireless network; wirelessly receiving in the first device a request to store the data from a remote control device; determining by the first device whether or not the first device is capable of storing the data; and if the first device is determined not to be capable of storing the data, wirelessly transmitting the data to the remote storage device via the wireless network, where the first device is one of an image display device and a set-top box configured to supply a signal to the image display device.

Also disclosed is an information processing apparatus configured to controllably store data in a remote storage device, and including: a remote controller interface unit; a wireless transceiver; and a controller operatively connected to the remote controller interface and the wireless transceiver, the controller configured to wirelessly receive the data via a wireless network, wirelessly receive a request to store the data from a remote control device via the remote controller interface unit, determine whether or not the information processing apparatus is capable of storing the data, and, if the information processing apparatus is determined not to be capable of storing the data, wirelessly transmit the data to the remote storage device via the wireless network, where the information processing apparatus is one of an image display device and a set-top box configured to supply a signal to the image display device.

Meanwhile, a display apparatus according to the embodiment of the present invention may include the receiving apparatus.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1 is a block diagram schematically illustrating a configuration of a transmitting/receiving system.

FIG. 2 is a block diagram illustrating a configuration of a transmitting/receiving system according to a first embodiment of the present invention.

FIG. 3 is a block diagram illustrating a configuration of a transmitting apparatus according to an embodiment of the present invention.

FIG. 4 is a block diagram illustrating a configuration of a receiving apparatus according to an embodiment of the present invention.

FIG. 5 is a flowchart illustrating a method for processing a signal according to a first embodiment of the present invention.

FIG. 6 is a flowchart illustrating a method for processing a signal according to a second embodiment of the present invention.

FIG. 7 is a block diagram illustrating a configuration of a transmitting/receiving system according to a second embodiment of the present invention.

FIG. 8 is a block diagram illustrating a configuration of a transmitting/receiving system according to a third embodiment of the present invention.

### DETAILED DESCRIPTION OF PREFERRED EMBODIMENTS

Hereinafter, a method for processing a signal, a transmitting apparatus, a receiving apparatus and a display apparatus thereof according to embodiments of the present invention will be described in detail with reference to the accompanying drawings.

FIG. 1 is a block diagram illustrating an embodiment of a configuration of a transmitting/receiving system. The transmitting/receiving system may include a transmitting apparatus 100 and a receiving apparatus 200.

Referring to FIG. 1, the transmitting apparatus 100 and the receiving apparatus 200 are connected with each other through a wireless network. The transmitting apparatus 100 receives the media signal including images from receives a media signal from a broadcasting system, a cable system, or external apparatuses and converts the received media signal into data of a wireless transmittable format and wirelessly transmits the data.

The receiving apparatus 200 receives and processes data wirelessly transmitted from the transmitting apparatus 100. For this, one or more wireless communication standards for wirelessly transmitting and receiving data may be previously established between the transmitting apparatus 100 and the receiving apparatus 200.

Meanwhile, the transmitting apparatus 100 includes various input terminals such as a high-definition multimedia interface (HDMI) terminal connected with an antenna or external apparatuses, a universal serial bus (USB) terminal, a component terminal, an external input terminal, an RGB terminal, an antenna cable terminal, etc. and can receive the signal by using the input terminals.

The transmitting apparatus 100 may be a set-top box (STB) that receives the media signal by using a wired or wireless network and converts and wirelessly transmits the received media signal to the receiving apparatus 200.

However, the transmitting apparatus 100 according to the embodiment of the present invention is not limited to the set-top box (STB) and may include all kinds of apparatuses that can receive the media signal transmitted from the outside and wirelessly transmit the received media signal to the receiving apparatus 200.

Further, the transmitting apparatus 100 according to the embodiment of the present invention may be implemented by being provided in a computer or a portal terminal such as a cellular phone, etc.

Further, the receiving apparatus 200 receives and processes the data wirelessly transmitted from the transmitting apparatus 100 and thereafter, can transmit the data to the external apparatus that outputs the video or audio included in the media signal.

For example, the receiving apparatus 200 can convert the video signal wirelessly transmitted from the transmitting apparatus 100 into a displayable format and output the video signal on a display apparatus (not shown). More specifically, when the video signal wirelessly transmitted from the transmitting apparatus 100 is encoded by a coding scheme such as an MPEG, etc., the receiving apparatus 200 decodes the received video signal to output the decoded video signal to the display apparatus (not shown).

According to the embodiment of the present invention, the transmitting apparatus 100 and the receiving apparatus 200 can transmit and receive the media signal by using various wireless communication standards, for example, wireless communication standards such as wireless HD (WiHD), wireless home digital interface (WHDi), wireless Lan (WiFi), etc.

The WiHD uses a frequency band of approximately 60 GHz and can transmit and receive data at transmission rate of approximately 4 Gbps to thereby transmit HD video data of 1080p (1920×1080) without compression. However, the WiHD uses high frequency of 60 GHz-band, such that a data transmitting/receiving distance is approximately 10 m and the transmission/reception quality may be easily influenced by obstacles in the vicinity of an installation space.

The WHDi can transmit and receive the data at transmission rate of approximately 1.8 Gbps by using a frequency band of approximately 5 GHz. Further, the WHDi uses a comparatively low high frequency band of 5 GHz, such that the data transmitting/receiving distance is approximately 30 m and the transmission/reception quality may not greatly be influenced by the obstacles in the vicinity of the installation space. Meanwhile, when the HD video data of 1080p (1920×1080) is transmitted by using the WHDi at the transmission rate of approximately 1.8 Gbps, the transmitting apparatus 100 needs to partially compress and transmit the HD video data.

Further, the WiFi can transmit and receive the data at transmission rate of approximately 54 Mbp by using a frequency band of approximately 2.4 GHz. The WiFi uses a comparatively low high frequency band of 2.4 GHz, such that the data transmitting/receiving distance is approximately 50 to 200 m and the transmission/reception quality may not almost be influenced by the obstacles in the vicinity of the installation space. Meanwhile, when the HD video data of 1080p (1920×1080) is transmitted by using the WiFi at the low transmission rate of approximately 54 Mbp, the transmitting apparatus 100 needs to compress and transmit the HD video data and as a result, the image quality of the video signal received from the receiving apparatus 200 may be deteriorated.

Meanwhile, the transmitting apparatus 100 and the receiving apparatus 200 can wirelessly transmit and receive the data depending the media signal by using various short-range wireless communication standards, for example, communication standards such as Bluetooth, ZigBee, or binary code division multiple access (CDMA), etc. in addition to the above-mentioned wireless communication standards.

The transmitting apparatus 100 and the receiving apparatus 200 can transmit and receive video and audio data by using any one of various wireless communication standards.

Meanwhile, the transmitting apparatus 100 and the receiving apparatus 200 may transmit and receive the video and audio data by using two or more wireless communication standards regarding performance, installation environment, video resolution, etc.

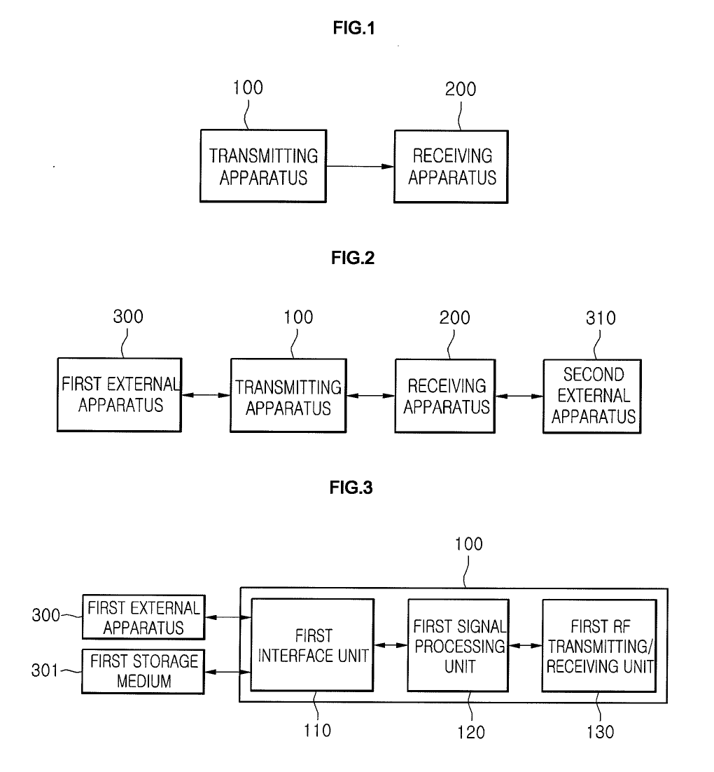

FIG. 2 is a block diagram illustrating a configuration of a transmitting/receiving system according to a first embodiment of the present invention. The system may include a transmitting apparatus 100, a receiving apparatus 200, and external apparatuses 300 and 310. The same components among the components of the transmitting/receiving system shown in FIG. 2 as the components described by referring to FIG. 1 will not be described below.

Referring to FIG. 2, the transmitting apparatus 100 and the receiving apparatus 200 can transmit and receive the data by using a wireless communication standard, i.e., WiHD, WHDi, WiFi, or the like.

The transmitting apparatus 100 may be connected to the first external apparatus 300. The transmitting apparatus 100 may receive the video signal and the audio signal from the first external apparatus 300. For this, the transmitting apparatus 100 may include input/output terminals such as an HDMI, a USB, a component, an RGB, etc. for transmitting and receiving the data to and from the first external apparatus 300.

Meanwhile, the receiving apparatus 200 may also be connected to the second external apparatus 310. The receiving apparatus 200 may receive the video signal and the audio signal from the second external apparatus 310. For this, the receiving apparatus 200 may include the input/output terminals for connecting the second external apparatus 310.

In FIG. 2, one external apparatus is connected to each of the transmitting apparatus 100 and the receiving apparatus 200, but the present invention is not limited thereto, that is, two or more external apparatuses may be connected to each of the transmitting apparatus 100 and the receiving apparatus 200.

Further, the external apparatuses 300 and 310 connected to the transmitting apparatus 100 or the receiving apparatus 200 may be various apparatuses including a video playing device such as a DVD player, a Dvix player or a blue-ray player, or the like, a set-top box such as an IPTV set-top box, a cable set-top box, a satellite set-top box, or the like, a PC, a game machine, a home theater, a portable terminal, a hard disk (HDD) recorder, etc.

However, the external apparatuses 300 and 310 according to the embodiment of the present invention is not limited to the above-mentioned apparatuses and may include various apparatuses that are connected to the transmitting device 100 or the receiving apparatus 200 to output the media signal such as the video signal.

According to the embodiment of the present invention, at least one of the transmitting apparatus 100 and the receiving apparatus 200 may include a storage medium (not shown) which can store an inputted signal or store the signal by being connected with an external storage medium (not shown).

For example, the transmitting apparatus 100 may receive the signal, more specifically, the video signal or the audio signal from the first external apparatus 100 and wirelessly transmit the inputted signal to the receiving apparatus 200. Meanwhile, the receiving apparatus 200 may store the video signal or the audio signal wirelessly transmitted from the transmitting apparatus 100 in the storage medium (not shown) provided therein or output and store the video signal or the audio signal to and in the storage medium (not shown) connected to the outside.

As described above, the video signal or the audio signal stored in the receiving apparatus 200 or the external storage medium (not shown) may be read from the storage medium (not shown) at a timing which a user desires, such that the video corresponding to the video signal may be displayed or the audio corresponding to the audio signal may be outputted.

As a result, the signal outputted from the external apparatus that cannot be directly stored in the receiving apparatus 200 due to a limitation in the installation space, for example, the first external apparatus 300 connected to the transmitting apparatus 100 that is most distant may also be transmitted by using the wireless network connected with the transmitting apparatus 100 and stored in the storage medium (not shown) of the receiving apparatus 200.

Meanwhile, the receiving apparatus 200 may receive the video signal or the audio signal from the connected second external apparatus 310 and may wirelessly transmit the inputted signal to the transmitting apparatus 100. The transmitting apparatus 100 may store the video signal or the audio signal wirelessly transmitted from the receiving apparatus 200 in the storage medium (not shown) provided therein or output and store the video signal or the audio signal to and in the storage medium (not shown) connected to the outside.

As described above, the video signal or the audio signal stored in the transmitting apparatus 100 or the external storage medium (not shown) may be read from the storage medium (not shown) at a timing which a user desires, such that the video signal or the audio signal may be transmitted to the receiving apparatus 200 or another external apparatus.

As a result, even when there is no storage medium that can store the signal inside or outside of the receiving apparatus 200, the signal inputted into the receiving apparatus 200, for example, the signal inputted from the second external apparatus 310 may be wirelessly transmitted to and stored in the transmitting apparatus 100.

That is, according to the embodiment of the present invention, it is possible to store and manage the video signal or the audio signal by efficiently the storage medium (not shown) provided in or connected to any one of the transmitting apparatus 100 and the receiving apparatus 200 by using the wireless network between the transmitting apparatus 100 and the receiving apparatus 200.

Meanwhile, an example of the storage medium may include an optical recording medium capable of writing or reading data by using light, a magnetic recording medium capable of writing or reading data by using a magnetic element, a non-volatile memory capable of writing or reading data by using a semiconductor chip, etc.

For example, the storage medium may include a DVD R/W and a CD R/W which is the optical recording medium, a magnetic tape or an HDD which is the magnetic recording medium, a compact flash card (CF card), a smart card, a portable memory stick, a multimedia card, a secure digital card (SD card), a USB memory, etc. which are the non-volatile memory.

Further, the storage medium is not limited to the media and may be implemented by various media that are connected with the transmitting apparatus 100 or the receiving apparatus 200 to receive and store the signal by receiving the signal from the transmitting apparatus 100 or the receiving apparatus 200.

Further, the storage medium may be implemented by an apparatus including the media. For example, the storage medium may be implemented by an external apparatus such as a PMP, a PDA, a cellular phone, a smart phone, etc., which can decode the media signal to output the video or audio signal.

FIG. 3 is a block diagram illustrating a configuration of a transmitting apparatus according to an embodiment of the present invention. The transmitting apparatus 100 may include a first interface unit 110, and a first signal processing unit 120, a first RF transmitting/receiving unit 130. The same components among the components of the transmitting apparatus 100 shown in FIG. 3 as the components described by referring to FIGS. 1 and 2 will not be described below.

Referring to FIG. 3, the first interface unit 110 is connected with the first external apparatus 300 to receive the signal. For this, the first interface unit 110 may include input terminals such as an HDMI, a USB, a component, an RGB, etc. for connecting the first external apparatus 300.

Meanwhile, the first interface unit 110 may be connected with a first storage medium 310, and may output and store the signal inputted into the transmitting apparatus 100, for example, the video signal or the audio signal to and in the first storage medium 301. Further, the first storage medium 301 may also be connected by using the input ports provided in the first interface unit 110.

For example, according to a user request, the first interface unit 110 may store the signals wirelessly transmitted from the receiving apparatus 200 or the other external apparatuses through the first RF transmitting/receiving unit 130 in the first storage medium 301. Alternately, the first interface unit 110 may store the signal inputted form the first external apparatus 300 in the first storage medium 301.

The first signal processing unit 120 may convert the signals inputted from the first external apparatus 300, for example, the video signal and the audio signal into data of a wirelessly transmittable format in accordance with a predetermined wireless communication standard and output the converted data.

For example, when the signal received from the first external apparatus 300 is encoded in accordance with a coding scheme such as an MPEG, etc., the first signal processing unit 120 may decode and output the received video and audio signals.

Meanwhile, the first signal processing unit 120 may be converted to data of a storable format so as to be stored in the first storage medium 301 and the converted data may be output to the first interface unit 110. For example, the first signal processing unit 120 may convert the outputted from the first RF transmitting/receiving unit 130 to the data of a storable transport stream (TP) format and add and output header information to the converted data.

The first RF transmitting/receiving unit 130 wirelessly transmits the signal outputted from the first signal processing unit 120 to the receiving apparatus 200. For this, the first RF transmitting/receiving unit 130 may include an antenna (not shown) and a converter (not shown), i.e., an up-converter and a down-converter.

Meanwhile, according to the embodiment of the present invention, the first RF transmitting/receiving unit 130 may receive the signal to be stored in the transmitting apparatus 100, more specifically, the first storage medium 301 connected to the transmitting apparatus 100 from the receiving apparatus 200.

In the above description, referring to FIG. 3, the embodiment of the present invention is described by using the case in which the transmitting apparatus 100 is connected with the external first storage medium 301 as an example, but the present invention is not limited thereto, that is, the first storage medium 301 may be provided in the transmitting apparatus 100.

Meanwhile, when no storage medium is provided in the transmitting apparatus 100, a function to store the signal, i.e., a function of a digital video recorder (DVR) may be activated only in a case in which the external first storage medium 301 shown in FIG. 3 is connected through the first interface unit 110.

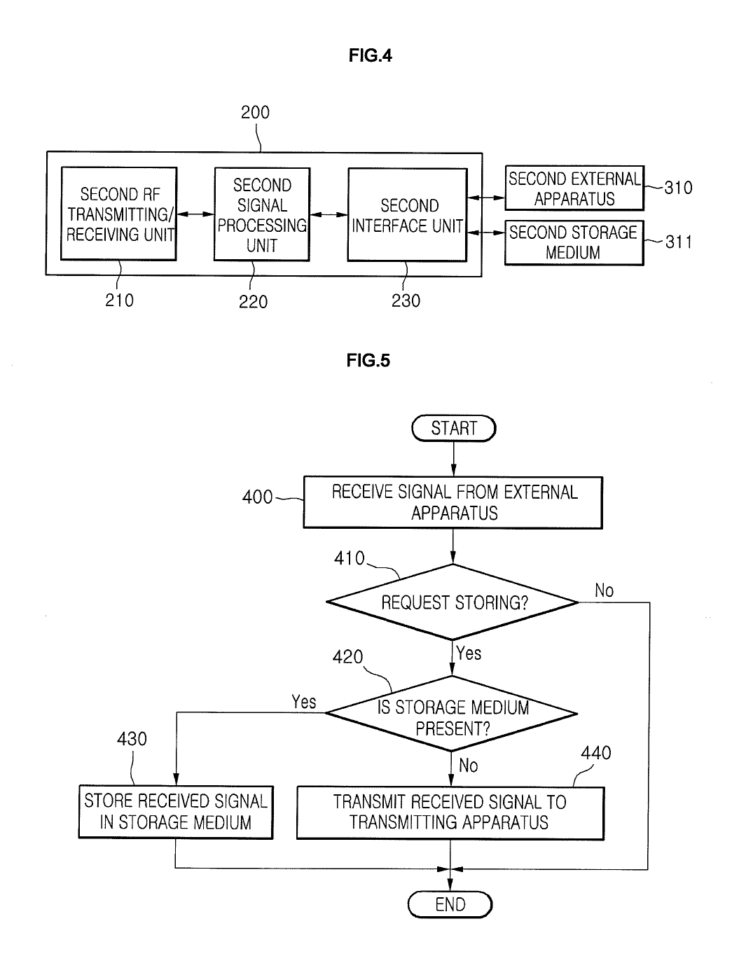

FIG. 4 is a block diagram illustrating a configuration of a receiving apparatus according to an embodiment of the present invention. The receiving apparatus 200 may include a second RF transmitting/receiving unit 210, a second signal processing unit 220, and a second interface unit 230.

Referring to FIG. 4, the second interface unit 230 may be connected with a second external apparatus 310 and a second storage medium 311 by using the input terminals such as the HDMI, the USB, the component, the RGB, etc.

Meanwhile, the second interface unit 230 may output and store the input signal inputted into the receiving apparatus 200, i.e., the video signal or the audio signal to and in the second storage medium 311.

For example, according to the user request, the second interface unit 230 may store signals inputted from the second external apparatus 310 through the second interface unit 230 or signals wirelessly transmitted from the transmitting apparatus 100 or the other external apparatuses through the second RF transmitting/receiving unit 210 in the second storage medium 311.

The second signal processing unit 220 may convert the signals inputted from the second external apparatus 310, for example, the video signal and the audio signal into the data of the wirelessly transmittable format in accordance with a predetermined wireless communication standard and output the converted data.

Meanwhile, when the signal received from the transmitting apparatus 100 or the second external apparatus 310 is encoded in accordance with a coding scheme such as an MPEG, etc., the second signal processing unit 220 may decode and output the received video and audio signals.

Meanwhile, the second signal processing unit 220 may convert a signal to be stored in the second storage medium 301 to the data of the storable format and output the converted data to the second interface unit 230. For example, the second signal processing unit 220 may convert the signal received from the transmitting apparatus 100 or the second external apparatus 310 to the data of the storable transport stream (TP) format and add and output the header information to the converted data.

The second RF transmitting/receiving unit 210 may wirelessly receive the media signal, for example, the video signal and the audio signal from the transmitting apparatus 100 and for this, may include an antenna (not shown) and a converter (not shown), more specifically, an up-converter and a down-converter.

Further, the receiving apparatus 200 may further include a display unit (not shown) for displaying the video signal received from the outside through the second RF transmitting/receiving unit 210 or the second interface unit 230. Alternately, the receiving apparatus 200 may output the received video signal to an external display apparatus (not shown) connected through the second interface unit 230.

According to the embodiment of the present invention, the second RF transmitting/receiving unit 210 may receive the signal to be stored in the receiving apparatus 200, more specifically, the second storage medium 311 connected to the receiving apparatus 200 from the transmitting apparatus 100.

Meanwhile, the signal to be stored, which is received from the transmitting apparatus 100 may be the video signal or the audio signal that is outputted from the first external apparatus 300 connected to the transmitting apparatus 100.

The signal received from the second RF transmitting/receiving unit 210 is processed by the second signal processing unit 220. Thereafter, the signal is inputted into the second interface unit 230 and may be outputted to and stored in the second storage medium through the second interface unit 230.

Meanwhile, the second RF transmitting/receiving unit 210 may wirelessly transmit the signal inputted from the second external apparatus 310 connected to the receiving apparatus 200 to the transmitting apparatus 100. For example, when the second storage medium 311 is not connected to the receiving apparatus 200, the second RF transmitting/receiving unit 210 may transmit the inputted signal to the transmitting apparatus 100 and store the signal in the first storage medium 301 that is provided in or connected to the transmitting apparatus 100.

In the above description, referring to FIG. 4, the embodiment of the present invention is described by using the case in which the receiving apparatus 200 is connected with the external second storage medium 311 as an example, but the present invention is not limited thereto, that is, the second storage medium 311 may be provided in the receiving apparatus 200.

Meanwhile, when no storage medium is provided in the receiving apparatus 200, the function of the DVR may be activated only in a case in which the external second storage medium 311 shown in FIG. 4 is connected through the second interface unit 230.

When the DVR function of the receiving apparatus 200 is not activated, the method verifies whether or not the storage medium is provided in or connected to the transmitting apparatus 100. At this time, when the storage medium is preset in the transmitting apparatus 100, the signal to be stored may be transmitted to the transmitting apparatus 100 by using the wireless network such as WiHD, WHDi, WiFi, or the like.

Hereinafter, a method for processing a signal according to an embodiment of the present invention will be described in more detail with reference to FIGS. 5 to 8.

FIG. 5 is a flowchart illustrating a method for processing a signal according to a first embodiment of the present invention and the method shown in FIG. 5 will be described by combining the receiving apparatus 200 shown in FIG. 4.

The second interface unit 230 of the receiving apparatus 200 receives the signal from a connected external apparatus, that is, the second external apparatus 310 (step 400). For example, depending on user' external input using a user input unit (not shown) provided in the receiving apparatus 200 and user's selection of contents, the second interface unit 230 may receive a video signal and an audio signal corresponding to the selected contents from the second external apparatus 310.

When the receiving apparatus 200 receives a request for storing the signal inputted from the second external apparatus 310 (step 410) from a user, the method verifies whether or not a storage medium provided in or connected to the receiving apparatus 200 is present (step 420).

For example, the user may request storing the signal inputted from the second external apparatus 310 by using the user input unit (not shown). In this case, it may be verified whether or not the second storage medium 311 is connected to the second interface unit 230.

According to the verification result, when the storage medium is present in the receiving apparatus 200, the signal inputted from the second external apparatus 310 is outputted to and stored in the second storage medium 311 (step 430).

For example, when the second storage medium 311 is connected to the second interface unit 230, the signal inputted from the second external apparatus 310 is outputted to the second signal processing unit 220 and is converted to a format storable in the second storage medium 311 and thereafter, may be outputted to the second storage medium 311 through the second interface unit 230.

Meanwhile, when no storage medium is present in the receiving apparatus 200, the second RF transmitting/receiving unit 210 wireless transmits the signal inputted from the second external apparatus 310 to the transmitting apparatus 100 (step 440).

For example, when the second storage medium 311 is not connected to the second interface unit 230, the signal inputted from the second external apparatus 310 is outputted to the second RF transmitting/receiving unit 210 through the second signal processing unit 220 and the second RF transmitting/receiving unit 210 may transmit the inputted signal to the transmitting apparatus 100 and store the transmitted signal in the storage medium that is provided in or connected to the transmitting apparatus 100.

According to yet another embodiment of the present invention, even when the second storage medium 311 is connected to the receiving apparatus 200, the system verifies a capacity of data that can be presently stored in the second storage medium 311. At this time, when the storable capacity is smaller than a reference value, the signal inputted from the second external apparatus 310 may be wirelessly transmitted to and stored in the transmitting apparatus 100.

By performing the signal processing method in the receiving apparatus 200, even when the storage medium is provided in or connected to only any one of the receiving apparatus 200 and the transmitting apparatus 100, the signal inputted into the receiving apparatus 200 from the second external apparatus 310 can be easily stored.

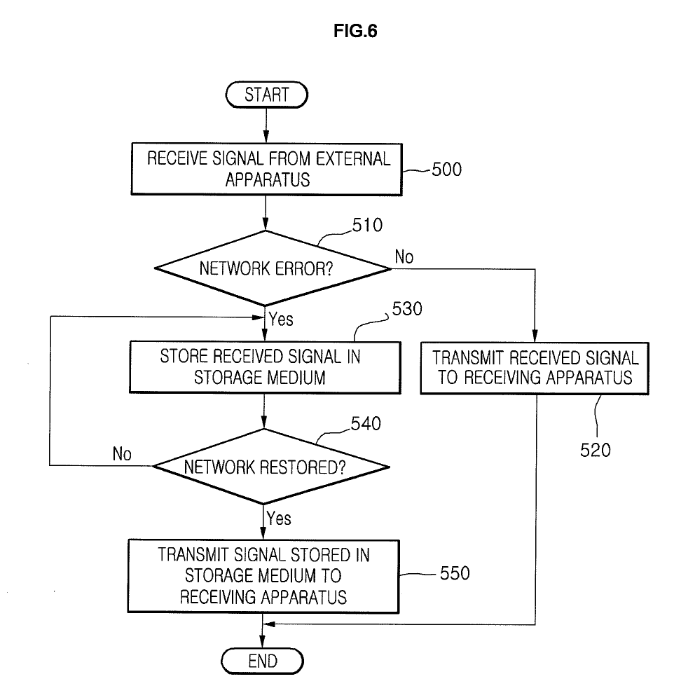

FIG. 6 is a flowchart illustrating a method for processing a signal according to a second embodiment of the present invention and the method shown in FIG. 6 will be described by combining the transmitting apparatus 100 shown in FIG. 3.

The first interface unit 110 of the transmitting apparatus 100 receives the signal from a connected external apparatus, that is, the first external apparatus 300 (step 500) and the first RF transmitting/receiving unit 130 transmits the inputted signal to the receiving apparatus 200 (step 520).

For example, depending on user' external input using the user input unit (not shown) provided in the transmitting apparatus 10 or the receiving apparatus 200 and user's selection of contents, the first interface unit 110 may receive a video signal and an audio signal corresponding to the selected contents from the first external apparatus 300.

The first signal processing unit 120 converts and outputs the signal outputted from the first interface unit 110 to data of a wirelessly transmittable format, for example, wireless data according to the wireless communication standard such as WiHD, WHDi, WiFi, or the like and the first RF transmitting and receiving unit 130 may wirelessly transmit the signal inputted from the first signal processing unit 120 to the receiving apparatus 200.

Meanwhile, while the signal is transmitted/received by using a wireless network between the transmitting apparatus 100 and the receiving apparatus 200, wireless communication performance is deteriorated due to external environments such as an appearance of an obstacle, interference with other signals, etc., such that an error may occur in the wireless network.

As described above, when the error occurs in the wireless network, the signal is not received in the receiving apparatus 200 or the error may occur in the signal received in the receiving apparatus 200. In this case, an image corresponding to the signal received in the receiving apparatus 200 may not be displayed or image quality may be deteriorated.

According to the embodiment of the present invention, while the first RF transmitting/receiving unit 130 transmits the signal to the receiving apparatus 200, the method verifies whether or not the error occurs in the wireless network between the transmitting apparatus 100 and the receiving apparatus 200 (step 510).

For example, the method can verify whether or not the error occurs in the wireless network at a predetermined cycle and by using signal reception sensitivity measured in the receiving apparatus 200, more specifically, a received signal strength indicator (RSSI) or a packet error rate (PER).

When no error occurs in the wireless network, the first RF transmitting/receiving unit 130 continuously transmits the signal inputted from the first external apparatus 300 to the receiving apparatus 200 (step 520).

Further, when the error occurs in the wireless network, the first interface unit 110 stores the signal inputted from the first external apparatus 300 in the first storage medium 301 (step 530).

According to yet another embodiment of the present invention, even when no occurs in the wireless network, the signal inputted from the first external apparatus 300 may be stored in the first storage medium 301 in real time.

Meanwhile, when the error occurs in the wireless network, the transmitting apparatus 100, more specifically, the first RF transmitting/receiving unit 130 may stop transmitting the signal to the receiving apparatus 200. In this case, the receiving apparatus 200 may report the user that signal reception may be stopped due to the error of the wireless network by using a display unit (not shown), etc. provided therein.

Thereafter, the method verifies whether or not the error of the wireless network between the transmitting apparatus 100 and the receiving apparatus 200 is restored (step 540).

For example, the method can verify whether or not the error of the wireless network is restored at a predetermined cycle after the error occurs.

When the error of the wireless network is restored, the first RF transmitting/receiving unit 130 receives the signal stored in the first storage medium 301 and transmits the received signal to the receiving apparatus 200 (step 550).

More specifically, at step 550, the first interface unit 110 receives the signal stored in the first storage medium 301 and converts the received signal to the wirelessly transmittable format through the first signal processing unit 120 and thereafter, may be wirelessly transmitted to the receiving apparatus 200 through the first RF transmitting/receiving unit 130.

At the timing when the error of the wireless network is restored, the receiving apparatus 200 may report the user that error of the wireless network is restored by using the display unit (not shown) provided therein.

Further, the receiving apparatus 200 may select whether to receive the signal from the timing when the error occurs again or to receive the signal presently outputted from the first external apparatus 300 as it is by using the use input unit (not shown) provided therein.

For example, when the user selects receiving the signal again from the timing when the error occurs, the first RF transmitting/receiving unit 130 receives the video signal stored in the first storage medium 301 and transmits the received video signal to the receiving apparatus 200, such that the user can watch the video again from the timing when the error occurs in the network.

Meanwhile, when the user selects receiving the signal outputted from the first external apparatus 300 as it is, the first RF transmitting/receiving unit 130 receives the signal outputted from the first external apparatus 300 and transmits the received signal to the receiving apparatus 200. At this time, the signal stored in the first storage medium 301 may be deleted.

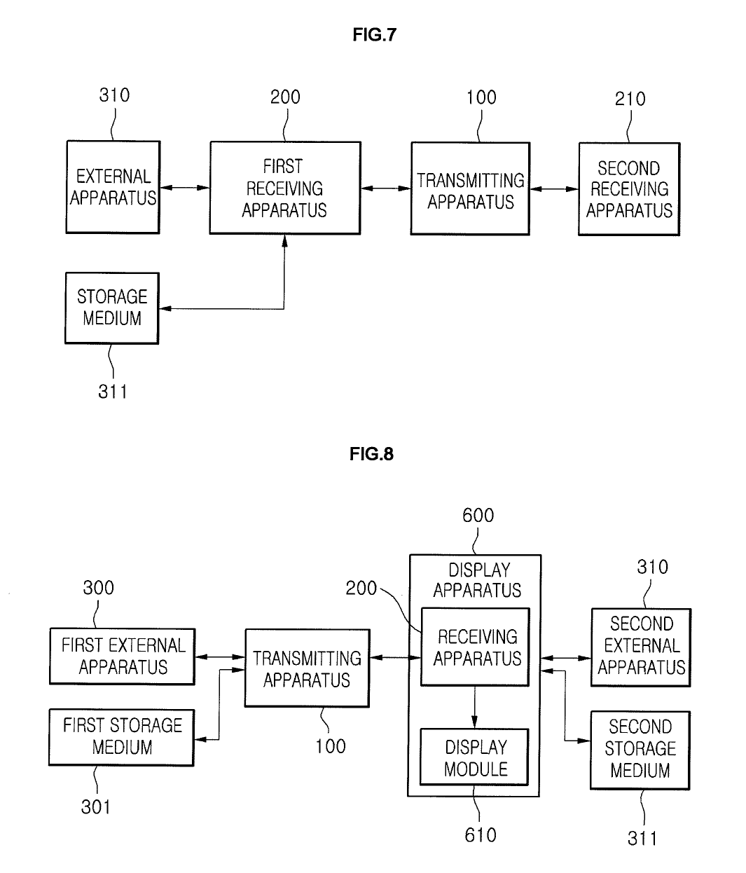

FIG. 7 is a block diagram illustrating a configuration of a transmitting/receiving system according to a second embodiment of the present invention. The same operations among the operations of the transmitting/receiving system shown in FIG. 7 as the operations described by referring to FIGS. 1 to 6 will not be described below.

Referring to FIG. 7, the transmitting apparatus 100 may be connected with the plurality of receiving apparatuses 200 and 210 through the wireless network. That is, the transmitting apparatus 100 converts the media signal received from the outside into wirelessly transmittable data and thereafter, may wirelessly transmit the data to at least one of the plurality of receiving apparatuses 200 and 210.

For example, the transmitting apparatus 100 may select one or more receiving apparatuses that will receive the media signal between the first and second receiving apparatuses 200 and 210 from the user and may wirelessly transmit the media signal received from the outside to the receiving apparatus selected by the user.

For this, the transmitting apparatus 100 may include a plurality of wireless transmitting units (not shown) corresponding to the first and second receiving apparatuses 200 and 210. The plurality of wireless transmitting units (not shown) may wirelessly transmit the video and audio data to the receiving apparatuses corresponding thereto.

The wireless communication standards for data transmission/reception may be the same as or different from each other in the plurality of receiving apparatuses 200 and 210. For example, in accordance with the performance or installation position of each of the first and second receiving apparatuses 200 and 210, the wireless communication standards for the first and second receiving apparatuses 200 and 210 to receive data may be established to be different from each other.

Meanwhile, the transmitting apparatus 100 may include a number smaller than the number of the first and second receiving apparatuses 200 and 210, for example, one wireless transmitting unit (not shown) and in this case, the transmitting apparatus 100 may wirelessly transmit the data by using multi-channel communication, that is, a plurality of channels corresponding to the first and second receiving apparatuses 200 and 210.

According to the embodiment of the present invention, the first receiving apparatus 200 may transmit the signal inputted from the external apparatus 310 to the transmitting apparatus 100 and the transmitting apparatus 100 may wirelessly transmit the received signal to the second receiving apparatus 210.

As a result, the second receiving apparatus 210 that is away from the first receiving apparatus 200 receives the signal outputted from the external apparatus 310 connected to the first receiving apparatus 200 through the transmitting apparatus 100 connected through the wireless network and may output the video or audio corresponding to the relevant signal.

Further, the first receiving apparatus 200 may transmit the signal stored in the storage medium 311 to the transmitting apparatus 100 and the transmitting apparatus 100 may wirelessly transmit the received signal to the second receiving apparatus 210.

As a result, the second receiving apparatus 210 that is away from the first receiving apparatus 200 receives the signal stored in the storage medium 311 of the first receiving apparatus 200 through the transmitting apparatus 100 connected through the wireless network.

The storage medium 311 may be connected to or provided in the first receiving apparatus 200 as shown in FIG. 7.

In FIG. 7, the embodiment of the present invention is described by using the case in which the first and second receiving apparatuses 200 and 210 are connected to the transmitting apparatus 100 through the wireless network as an example, but the present invention is not limited thereto and three or more receiving apparatuses may be connected to the transmitting apparatus 100 through the wireless network to transmit and receive the signal.

FIG. 8 is a block diagram illustrating a configuration of a transmitting/receiving system according to a third embodiment of the present invention. The same operations among the operations of the transmitting/receiving system shown in FIG. 8 as the operations described by referring to FIGS. 1 to 7 will not be described below.

Referring to FIG. 8, a display apparatus 600 according to the embodiment of the present invention may include the receiving apparatus 200 having the above-mentioned configuration and a display module 610.

That is, the transmitting apparatus 100 receives the media signal from the outside and wirelessly transmits the received media signal to the receiving apparatus 200 and the receiving apparatus 200 provided in the display apparatus 600 processes the wirelessly transmitted data into a video signal of a displayable format to output the processed data to the display module 610.

The display module 610 may display a video by using the video signal inputted from the receiving apparatus 200. For this, the display module 610 may include display panels (not shown) of various display types such as a liquid crystal display (LCD), a plasma display panel (PDP), an electro luminescent display (ELD), a vacuum fluorescent display (VFD), etc.

Meanwhile, as shown in FIG. 8, the first external apparatus 300 and the first storage medium 301 may be connected to the transmitting apparatus 100 and the second external apparatus 310 and the second storage medium 311 may also be connected to the display apparatus 600.

Further, the signal processing method according to the present invention may be stored in a computer-readable recording medium by being produced as a program to be executed in a computer. An example of the computer-readable recording medium includes a ROM, a RAM, a CD-ROM, a magnetic tape, a floppy disk, an optical data storage, etc.

According to the embodiment of the present invention, by storing the signal inputted into the transmitting apparatus or the receiving apparatus by using the wireless network between the broadcast transmitting and receiving apparatuses, it is possible to efficiently store and manage the video or audio signal inputted from the external apparatus.

The computer-readable recording media are distributed on computer systems connected through a network, and thus a computer-readable code may be stored and executed by a distribution scheme. In addition, a functional program, a code, and code segments for implementing the broadcast receiving method will be easily interred by programmers skilled in the art.

Each of the devices described above may include one or more controllers or control units to interface with various components and to execute the methods described herein.

Although preferred embodiments of the present invention have been illustrated and described, the present invention is not limited to the above-mentioned embodiments and various modified embodiments can be available by those skilled in the art without the scope of the appended claims of the present invention. In addition, these modified embodiments should not be appreciated separately from technical spirits or prospects.

What is claimed is:

1. A method for controllably storing data in a remote storage device by a first device, comprising:
wirelessly receiving the data by the first device via a wireless network;
wirelessly receiving in the first device a request to store the data from a remote control device;
determining by the first device whether or not the first device is capable of storing the data; and
if the first device is determined not to be capable of storing the data, wirelessly transmitting the data to the remote storage device via the wireless network,
wherein the first device is one of an image display device and a set-top box configured to supply a signal to the image display device.

2. The method of claim 1, wherein the step of wirelessly transmitting the data to the remote storage device comprises:
temporarily buffering the data by the first device.

3. The method of claim 1, further comprising:
wirelessly receiving by the first device via the wireless network at least one of
information about the remote storage device,
contents of the remote storage device,
information about the contents of the remote storage device,
broadcast data, and
information about the broadcast data.

4. The method of claim 1, wherein the step of determining by the first device whether or not the first device is capable of storing the data comprises one of:
determining whether an internal storage of the first device is capable of storing the data; and
determining whether an external storage, directly connected or wirelessly connected to the first device, is capable of storing the data.

5. The method of claim 1, wherein the steps of wirelessly receiving and transmitting comprise receiving and transmitting via one of WiHD, WHDi, and WiFi.

6. The method of claim 1, wherein the step of wirelessly transmitting the data to the remote storage device via the wireless network comprises:
wirelessly transmitting the data to the remote storage device via a second device,
wherein the second device is one of a second image display device and a second set-top box connected to the second image display device.

7. The method of claim 1, the step of wirelessly transmitting the data to the remote storage device via the wireless network comprising:
determining that an error has occurred in the wireless network;
storing a portion of the data in the first device received after the error was determined to have occurred and for a duration of the error;
determining by the first device that the error has ended and that a wireless connection to the remote storage device is restored; and
wirelessly transmitting one of the stored portion and a post-network restoration signal from the first device to the remote storage device after the wireless connection to the remote storage device is determined to be restored.

8. The method of claim 7, wherein the step of wirelessly transmitting the one of the stored portion and the post-network restoration signal comprises:
wirelessly transmitting the one of the stored portion and the post-network restoration signal in response to a user-generated selection of the one of the stored portion and the post-network restoration signal received from the remote control device.

9. An information processing apparatus configured to controllably store data in a remote storage device, comprising:
a remote controller interface unit;
a wireless transceiver; and
a controller operatively connected to the remote controller interface unit and the wireless transceiver, the controller configured to
wirelessly receive the data via a wireless network,
wirelessly receive a request to store the data from a remote control device via the remote controller interface unit,
determine whether or not the information processing apparatus is capable of storing the data, and
if the information processing apparatus is determined not to be capable of storing the data, wirelessly transmit the data to the remote storage device via the wireless network,
wherein the information processing apparatus is one of an image display device and a set-top box configured to supply a signal to the image display device.

10. The information processing apparatus of claim 9, further comprising:
a buffer,
wherein the controller is configured to temporarily buffer the data by the first device.

11. The information processing apparatus of claim 9, wherein the controller is configured to wirelessly receive at least one of
information about the remote storage device,
contents of the remote storage device,
information about the contents of the remote storage device,
broadcast data, and
information about the broadcast data.

12. The information processing apparatus of claim 9, wherein the controller is configured to determine one of:
whether an internal storage of the information processing apparatus is capable of storing the data; and
whether an external storage, directly connected or wirelessly connected to the information processing apparatus, is capable of storing the data.

13. The information processing apparatus of claim 9, wherein the wireless transceiver is configured to receive and transmit via one of WiHD, WHDi, and WiFi.

14. The information processing apparatus of claim 9,
wherein the controller is configured to wirelessly transmit the data to the remote storage device via a second device, and
wherein the second device is one of a second image display device and a second set-top box connected to the second image display device.

15. The information processing apparatus of claim 9, wherein the controller is configured to
determine that an error has occurred in the wireless network,
store a portion of the data received after the error was determined to have occurred and for a duration of the error,
determine that the error has ended and that a wireless connection to the remote storage device is restored, and
wirelessly transmit one of the stored portion and a post-network restoration signal to the remote storage device after the wireless connection to the remote storage device is determined to be restored.

16. The information processing apparatus of claim 15, wherein the controller is configured to wirelessly transmit the one of the stored portion and the post-network restoration signal in response to a user-generated selection of the one of the stored portion and the post-network restoration signal received from the remote control device.
